(19) United States
(12) Patent Application Publication
(10) Pub. No.: US 2007/0088748 A1
(43) Pub. Date: Apr. 19, 2007

(54) Image display control device

(75) Inventors: Eiichi Matsuzaki, Kawasaki (JP); Aki Kita, Kawasaki (JP); Isao Funaki, Kawasaki (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 11/403,008

(22) Filed: Apr. 13, 2006

(30) Foreign Application Priority Data
Oct. 17, 2005 (JP) JP2005-301429

(51) Int. Cl. G06F 17/00

(52) U.S. Cl. 707/104.1

(57) ABSTRACT

To facilitate selection of a desired image by displaying respective object images in a layout corresponding to a satisfaction level of a keyword and a similarity level of the image. An input of a keyword is received, a reference image is selected, a satisfaction level is calculated based on keywords assigned to a plurality of object images and the inputted keyword, a similarity level of the object image to the reference image is calculated, and the respective object images are displayed on multidimensional coordinates in the layout corresponding to the satisfaction level of the keyword and the similarity level of the image.

### BACKGROUND OF THE INVENTION

The present invention relates to a technology of displaying a plurality of images in a layout corresponding to similarity levels.

Over the recent years, there have been proposed a variety of searching methods employed for users to obtain a desired image from within multiple pieces of image data, and, for example, the known methods are given as below.

(1) A computer generally has a function (such as Explorer) for displaying files in a one-dimensional layout. With this function, the image files are list-displayed in the sequence according to a file name, a file size, a date, etc. The user sequentially scans the list-displayed file names and thumbnail images, thereby searching out the desired image. On this occasion, the image files can be also list-displayed after narrowing down the image files with dates and characters contained in the file names.

(2) [Miyoue] (which is a three-dimensional image browser) (registered trademark) available as software for searching for images is such that the images are laid out within a two- or three-dimensional space by use of a color distribution of the images, an image capturing time or a similarity level to a reference image (Non-Patent document 1).

(3) Proposed is an image search device for searching for a similar image by searching for the image with a keyword and setting this image as a reference image (Patent document 1).

Further, the following documents are known. (Patent documents 2, 3)

[Non-Patent document 1] Miyoue, 2000-2005, Fujitsu Oita Software Laboratory Corp., [Jun. 6, 2005], Internet <http://www.osl.fujitsu.com/miyoue/first.html>

[Patent document 1] Japanese Patent Application Laid-Open Publication No. 2000-148794

[Patent document 2] Japanese Patent Application Laid-Open Publication No. 2001-117936

[Patent document 3] Japanese Patent Application Laid-Open Publication No. 2000-148793

### SUMMARY OF THE INVENTION

As described above, if the images are one-dimensionally displayed according to the file names and the dates, the images are enumerated irrespective of the image similarity, and it is therefore difficult to search for the desired image.

Further, [Miyoue] given above determines the image layout corresponding to the similarity level to the reference image and is therefore unsuited to searching for an image exhibiting a low similarity level.

Moreover, in the keyword-based search, none of the files containing no keyword are displayed. Hence, it is impossible to take account of a relational level between the keywords.

Furthermore, in a method of searching for a similar image by employing the image containing the keyword as a reference image, it is unfeasible to simultaneously search for the image that is low of the similarity level of the image itself but is high of the relational level of the keyword associated with the image.

Such being the case, according to the invention, selection of the desired image is facilitated by displaying respective object images in a layout corresponding to a satisfaction level of the keyword and a similarity level of the image.

The invention adopts the following configurations in order to solve the problems.

Namely, an image display control device of the invention is an image display control device that displays a plurality of object images in a layout corresponding to similarity levels thereof, the image display control device comprising:

a keyword input unit receiving an input of a keyword;

a reference image selecting unit selecting a reference image;

a keyword evaluating unit calculating a satisfaction level of the keyword on the basis of a keyword assigned to each object image and the inputted keyword;

a image evaluating unit calculating a similarity level of each object image by comparing the object image with the reference image; and

a display control unit having the respective object images displayed in the layout corresponding to the satisfaction level of the keyword and the similarity level of the image.

The display control unit may display the plurality of images on coordinates corresponding to the satisfaction levels and the similarity levels thereof, in which at least the satisfaction level of the keyword and the similarity level of the image are taken on coordinate axes.

The keyword evaluating unit may refer to a keyword table stored hierarchically with the keywords, and may calculate the satisfaction level on the basis of a difference in hierarchy between the keyword assigned to the object image and the inputted keyword.

The reference image selecting unit may select, as the reference image, an image exhibiting the keyword satisfaction level that satisfies a predetermined condition in the plurality of the object images.

Further, an image display control method of the invention is a method by which a computer displays a plurality of object images in a layout corresponding to similarity levels thereof, the control method comprising steps of:

receiving an input of a keyword;

selecting a reference image;

calculating a satisfaction level on the basis of a keyword assigned to each object image and the inputted keyword;

calculating a similarity level of each object image by comparing the object image with the reference image; and

having the respective object images displayed in the layout corresponding to the satisfaction level of the keyword and the similarity level of the image.

In the image display control method, the object image displaying step may involve displaying the plurality of images on coordinates corresponding to the satisfaction levels and the similarity levels thereof, in which at least the satisfaction level of the keyword and the similarity level of the image are taken on coordinate axes.

In the image display control method, the keyword satisfaction level calculating step may involve referring to a keyword table stored hierarchically with the keywords, and calculating the satisfaction level on the basis of a difference in hierarchy between the keyword assigned to the object image and the inputted keyword.

In the image display control method, the reference image selecting step may involve selecting, as the reference image, an image exhibiting the satisfaction level of keyword that satisfies a predetermined condition in the plurality of the object images.

Moreover, the invention may also be an image display control program for making a computer execute the image display control method. Still further, the invention may further be a readable-by-computer recording medium recorded with this image display control program. The computer is made to read and execute the program on this recording medium, whereby the function thereof can be provided.

Herein, the readable-by-computer recording medium connotes a recording medium capable of storing information such as data and programs electrically, magnetically, optically, mechanically or by chemical action, which can be read from the computer. Among these recording mediums, for example, a flexible disc, a magneto-optic disc, a CD-ROM, a CD-R/W, a DVD, a DAT, an 8 mm tape, a memory card, etc. are given as those demountable from the computer.

Further, a hard disc, a ROM (Read-Only Memory), etc. are given as the recording mediums fixed within the computer.

According to the invention, it is possible to provide the technology that facilitates the selection of the desired image by displaying the respective object images in the layout corresponding to the satisfaction level of the keyword and the similarity level of the image.

### BRIEF DESCRIPTION OF THE DRAWINGS

FIG. 1 is a schematic diagram of an image display control device according to the invention.

FIG. 2 is a flowchart of an image display control method in a first embodiment according to the invention.

FIG. 3 is an explanatory diagram of a user interface.

FIG. 4 is a diagram showing an example of a display result.

FIG. 5 is a flowchart of a process of obtaining a satisfaction level from a hierarchical depth in a keyword tree.

FIG. 6 is a diagram showing a display example of the keyword tree.

FIG. 7 is a diagram showing a storage format of the keyword tree.

FIG. 8 is an explanatory diagram of an object keyword table.

FIG. 9 is a flowchart of a process of acquiring a parent list.

FIG. 10 is an explanatory diagram of a process of obtaining a keyword distance.

FIG. 11 is a diagram showing an example of the satisfaction level obtained from the hierarchical depth of the keyword tree.

FIG. 12 is a flowchart of a process of acquiring the satisfaction level from a structure of the keyword tree.

FIG. 13 is a diagram showing an example of the satisfaction level obtained from the structure of the keyword tree.

FIG. 14 is a flowchart of the image display control method in a second embodiment according to the invention.

### DETAILED DESCRIPTION OF THE PREFERRED EMBODIMENT

### First Embodiment

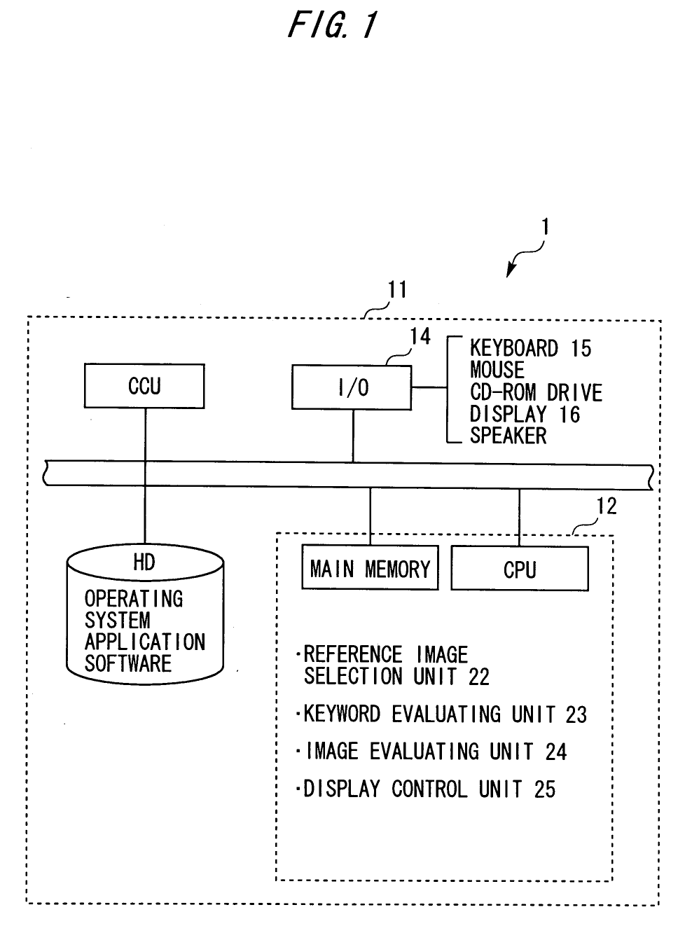

FIG. 1 is a schematic diagram of an image display control device (an image search display device) according to the invention. An image search display device 1 in this example three-dimensionally displays a plurality of object images in a layout corresponding to similarity levels, thereby enabling a user to easily find out a desired image.

As shown in FIG. 1, the image search display device 1 is a general-purpose computer including an arithmetic processing unit 12 executing an arithmetic process of information, a storage unit 13 stored with data and software for the arithmetic process, an input/output port 14 and so on.

Connected properly to the I/O port 14 are input devices such as a keyboard (keyword input unit) 15, a mouse and a tablet, and output devices such as a display means (display) 16 and a printer.

The storage unit 13 is a storage means such as a hard disc and is preinstalled with an operating system (OS) and an application program (image display control program). Further, the storage unit 13 includes an evaluation keyword table stored with keywords in a tree structure (hierarchical structure) as standards for evaluating the keywords and a database stored with the object images together with the keywords.

The arithmetic processing unit 12, which is constructed of a CPU (Central Processing Unit), a main memory, etc, properly reads the OS and the application program from the storage unit 13, then executes the OS and the application program, and executes the arithmetic process of the information inputted from the I/O port 14 and the information read from the storage unit 13, thereby functioning as a reference image selection unit 22, a keyword evaluating unit 23, an image evaluating unit 24 and a display control unit 25.

The arithmetic processing unit 12, as the reference image selection unit 22, selects a reference image based on a user's operation. This reference image may be selected from within the object images, and other images may also be usable.

The arithmetic processing unit 12 functioning as the keyword evaluating unit 23 calculates a satisfaction level of the keyword on the basis of a keyword (object keyword) assigned to each object image and a keyword (inputted keyword) inputted from the keyword input unit. in the embodiment, the keyword evaluating unit 23 refers to the evaluation keyword table, and thus calculates a similarity level on the basis of a difference in hierarchy between the object keyword and the inputted keyword.

The arithmetic processing unit 12 functioning as the image evaluating unit 24 calculates the similarity level of the image by comparing each object image with the reference image.

The arithmetic processing unit 12 functioning as the display control unit 25 displays each object image on multidimensional coordinates in a layout corresponding to the satisfaction level of the keyword and the similarity level of the image. For instance, the display control unit 25 takes three coordinate axes such as the satisfaction level of the keyword, the similarity level of the image and a date/time for display areas, wherein the object image is three-dimensionally displayed by laying out the object image in the coordinates corresponding to the satisfaction level of the keyword, the similarity level of the image and the date/time.

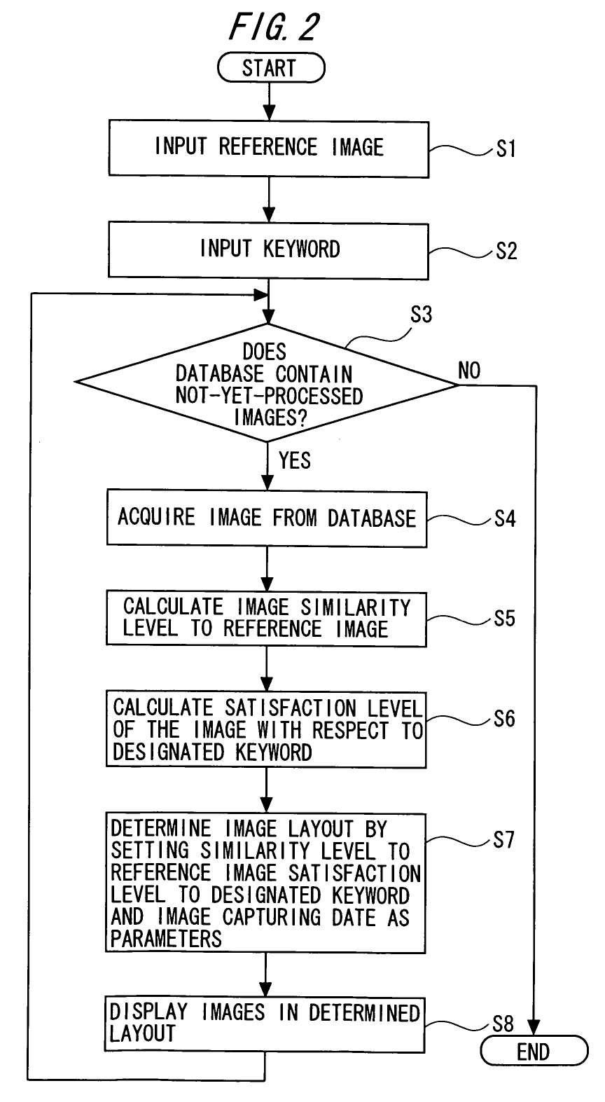

FIG. 2 is an explanatory flowchart of an image display control method of displaying a search result of the desired image by the image search display device 1.

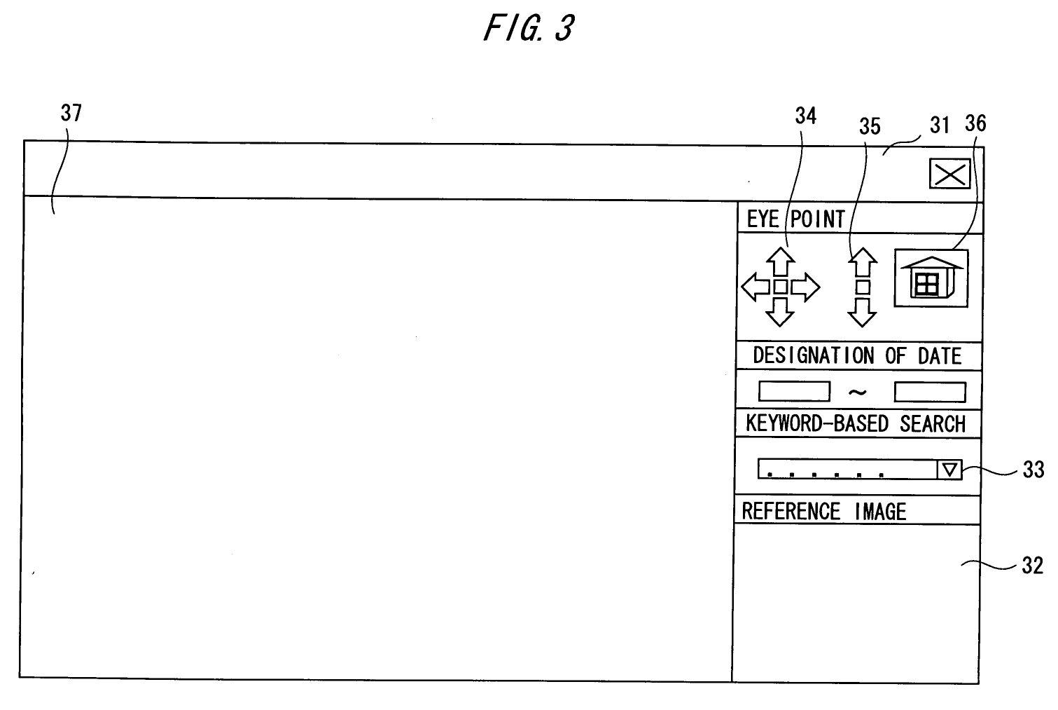

When the user operates to start searching, the image search display device 1 reads the image display control program from the storage unit 13 and the executes the control program, thereby displaying, as shown in FIG. 3, a window 31 serving as a user interface on the display 16. When the user inputs an image similar to the want-to-search image to the window 31, the reference image selection unit 22 of the image search display device 1 selects this inputted image as the reference image and displays the reference image in a reference image display box 32 (step 1, which will hereinafter be abbreviated such as S1). Herein, the image input may be done by any method if capable of specifying the image such as dragging and dropping the image to the display box 32, inputting an image path from the keyboard 15 and doing a handwriting input with the mouse and the tablet.

Next, when the user inputs a keyword (inputted keyword) of the want-to-search image to a keyword input box 33 from on the keyboard 15, the image search display device 1 receiving the input of the keyword temporarily stores this inputted keyword on the main memory of the arithmetic processing unit 12 (S2).

For executing a process of calculating the similarity level of each object image and the satisfaction level thereof with respect to the reference image and the inputted keyword, it is judged whether or not the image database contains a not-yet-processed object image (S3), and, if the not-yet-processed object image exists therein, this image is acquired (S4).

With respect to the acquired object image, the image evaluating unit 24 calculates the similarity level to the reference image (S5). It is to be noted that algorithm for obtaining this similarity level may involve using any method capable of converting the similarity level of the image into a numerical value. For example, a three-dimensional histogram is generated by laying out RGB (Red, Green, Blue) values of respective pixels that form the object image and the reference image in two-dimensional space coordinates, color distributions of the respective images are converted into the numerical values, and the similarity level of the object image to the reference image is acquired. Further, in this example, the color distributions of the respective object images are stored. Note that this color distribution may be expressed in the numerical values corresponding to the color distribution, wherein, for example, positions of principal colors and positions of specified colors (such as a skin color and a sky color) are converted into numerical values.

Subsequently, the keyword evaluating unit 23 calculates the satisfaction level of the object keyword assigned to the object image with respect the inputted keyword (S6).

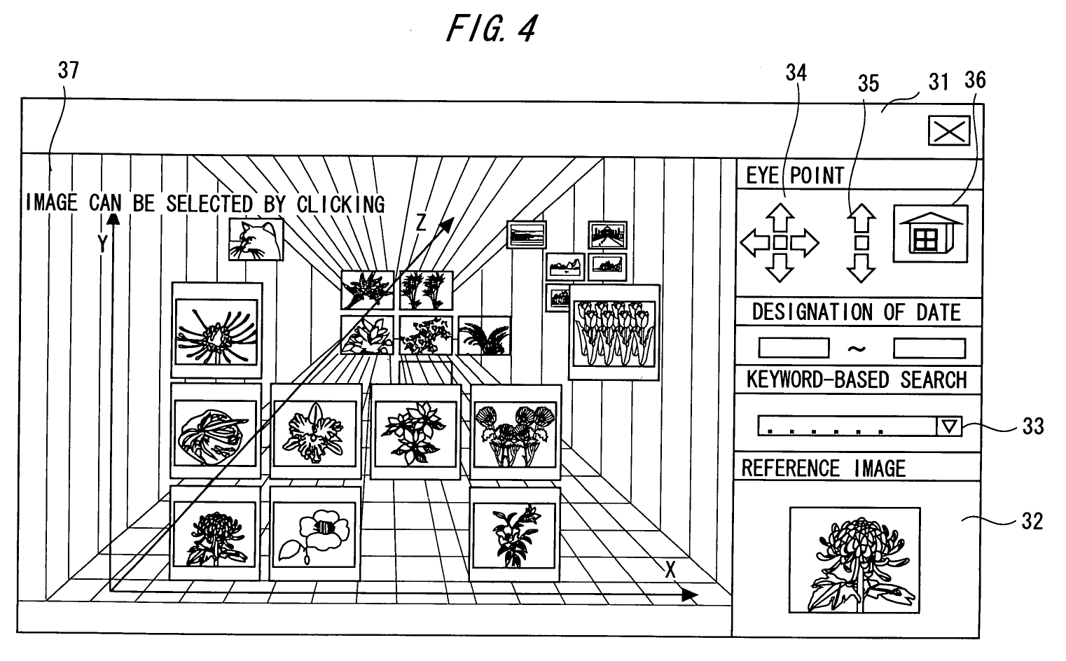

The display control unit 25 determines the layout (coordinates) by using, as parameters, the satisfaction level of the object keyword, the similarity level of the image, an image capturing date and the image color distribution (S7), and displays, in this layout, as illustrated in FIG. 4, a reduced image (thumbnail image) in a result display box 37 on the window 31 (S8). In FIG. 4, the image capturing date is taken on the X-axis, the image color distribution is taken on the Y-axis, and a total value of the satisfaction level of the keyword and the similarity level of the image is taken on the Z-axis. Note that on the X-axis, the updated image capturing date/time serves as its origin, wherein a position farther from the origin represents an older (more previous) image capturing date/time. On the Y-axis, a value of the color distribution of the reference image serves as its origin, wherein a position farther from the origin represents a larger difference from the value of the reference image. Moreover, on the Z-axis, its origin corresponds to a case where the satisfaction level is “1” and the similarity level is “1”, a position father from the origin represents a lower satisfaction level and a lower similarity level as well.

Then, returning to step 3, the process of displaying corresponding to the satisfaction level and the similarity level is repeated, wherein the processing comes to an end when the not-yet-processed images disappear. Note that FIG. 4 illustrates an initial screen (home position) at a point of time when the processing is completed. Hereat, the display control unit 25 sets a scale so that all the images are displayed within the single screen in a way that lays out the object images according to the respective parameters, and provides such display that the origins on the individual axes converge at the left lower end. In the embodiment, the reference image is displayed at the origins. Further, the image is displayed in a way that moves a view point within an X-Y plane corresponding to an operation of a move button 34 and that moves the view point in the Z-direction corresponding to an operation of a move button 35. Herein, when selecting each image, the selected image is displayed in enlargement. Further, the display is returned to the home position (initial screen) by pressing a home button 36.

Thus, the plurality of object images is displayed in the sequence from the highest similarity to the keyword and to the reference image that are inputted by the user, and the image can be selected while moving the view point, thereby enabling the desired image to be easily searched for.

It should be noted that the parameters taken on the respective axes may be, without being limited to those given above, values using the satisfaction level of the keyword and the similarity level of the object image. For instance, the satisfaction level of the keyword may be taken on the Y-axis, the similarity level of the object image may be taken on the X-axis, and the image capturing date/time may be taken on the Z-axis. Alternatively, the images may also be displayed on the two-dimensional coordinates, wherein the satisfaction level of the keyword is taken on the X-axis, and the similarity level of the object image is taken on the Y-axis.

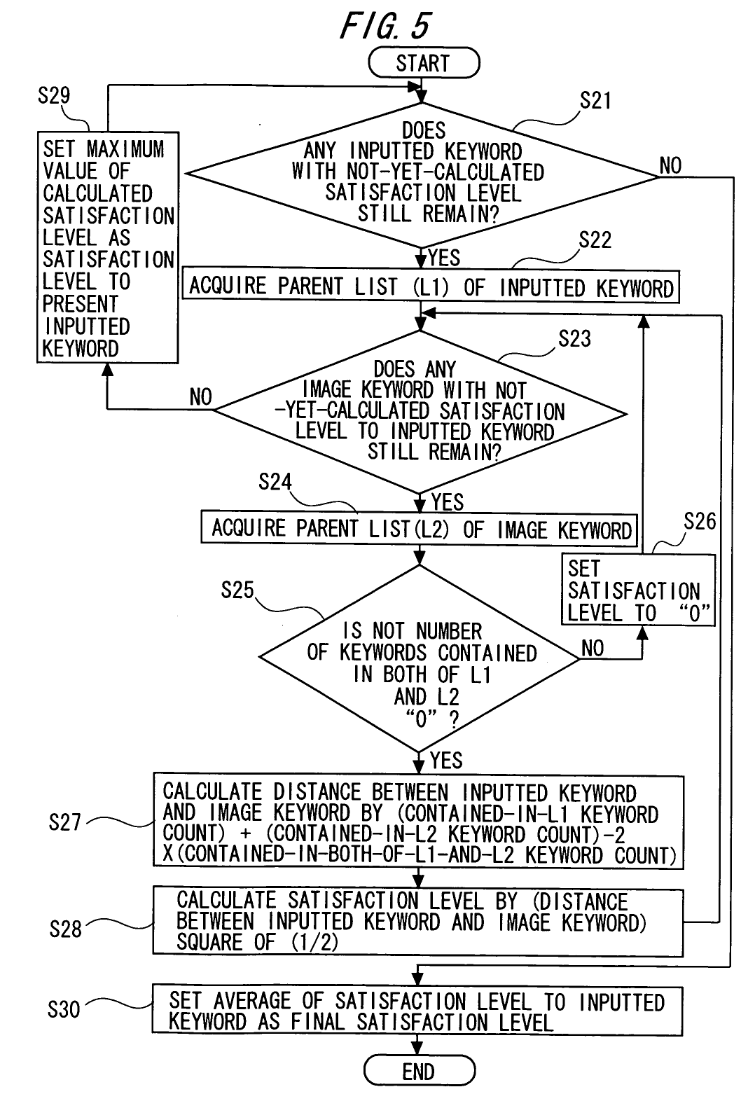

Next, an in-depth explanation of the process of obtaining the satisfaction level of the keyword in step 6 will be given with reference to FIG. 5.

To start with, the keyword evaluating unit 23 judges whether or not there still remain the inputted keywords of which the satisfaction levels are not yet calculated (S21), and, if the not-yet-calculated keywords remain, a parent list (L1) of the inputted keywords is acquired (S22).

Further, it is judged whether or not there exists, in the object keywords, any object keyword of which the satisfaction level to the inputted keyword is not yet calculated (S23). If the not-yet-calculated object keyword exists, a parent list (L2) is acquired (S24).

It is judged whether or not the number of keywords (keyword count) contained in both of the parent list L1 and the parent list L2 is other than “0” (S25), and, if this keyword count is “0”, after setting the satisfaction level to “0”, the processing returns to step 23 (S26). Whereas if not “0”, a distance between the inputted keyword and the object keyword is calculated by the following formula (S27).
D=CL1+CL2−2×C (Formula 1)
where

D: the distance between the inputted keyword and the object keyword,

CL1: the number of the keywords contained in the parent list L1

CL2: the number of the keywords contained in the parent list L2

C: the number of the keywords contained both in the parent list L and in the parent list L2.

The keyword evaluating unit 23 obtains a satisfaction level M by use of this distance D (S28).
M=(½)^{D} (Formula 2)

After obtaining this satisfaction level M, the keyword evaluating unit 23 returns to step 23 and repeats these steps (S23-S28) till there disappear the object keywords of which the satisfaction level M is not yet obtained. Then, when the object keywords of which the satisfaction level M should be obtained disappear, the maximum value in the satisfaction levels of the object keywords with respect to this inputted keyword is set as the satisfaction level to the inputted keyword (S29), and the processing returns to step 21.

In step 21, the keyword evaluating unit 23 repeats the steps 22 through 29 till judging that none of the inputted keywords with the not-yet-obtained satisfaction level are left. Then, in the case of obtaining the satisfaction levels to all the inputted keywords, an average of the satisfaction levels to all these inputted keywords is determined as a final satisfaction level (S30).

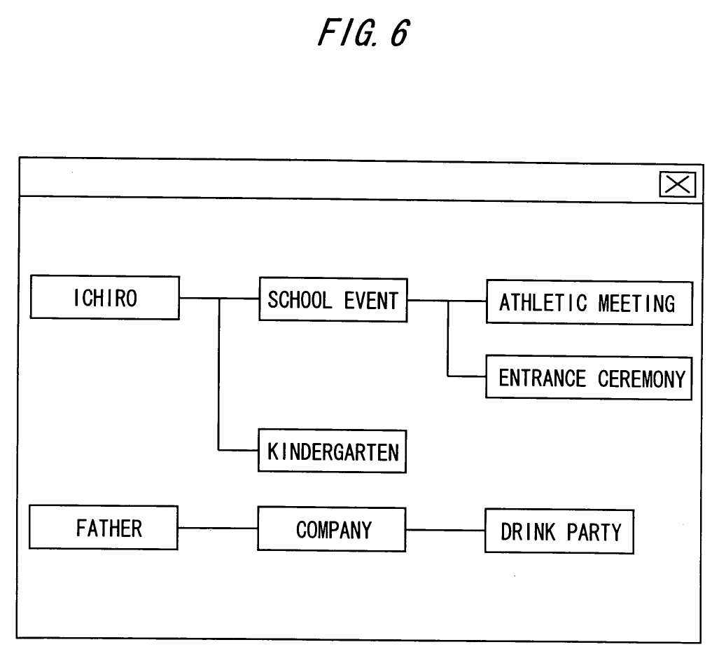

Note that a keyword tree showing a relationship between the respective keywords is preset for obtaining the satisfaction level of this keyword. FIG. 6 is a diagram showing a display example of the keyword tree set in the embodiment.

In FIG. 6, the keywords (Ichiro, Father) on the uppermost layer are shown at the left end, and the keywords on the lower layers are shown on the more right side. Namely, “School event” and “Kindergarten” are disposed on the low layer under “Ichiro”, and “Entrance ceremony” and “Athletic meeting” are disposed on the layer under the “School event”.

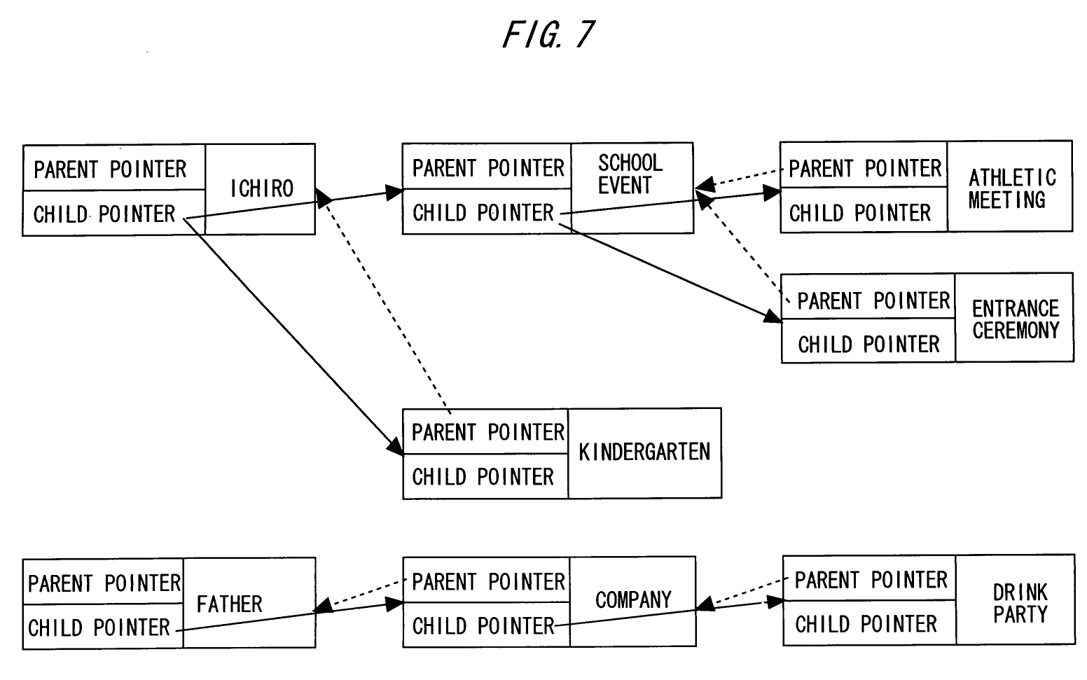

Specifically, as shown in FIG. 7, each key word is given as an aggregation including a parent pointer that points the keyword on the high layer and a child pointer that points the keyword on the low layer. It is to be noted that the parent pointers of keywords on the uppermost layer are invalid, while the child pointers of the keywords on the lowermost layer are invalid.

This keyword tree can be edited by the user as the user intends, wherein, for instance, the window 41 in FIG. 6 is displayed, and the user selects “School event”, then gives an instruction of adding low layer keywords and inputs the keywords from on the keyboard 15, whereby a keyword coordinate with the “Entrance ceremony” and “Athletic meeting” is added.

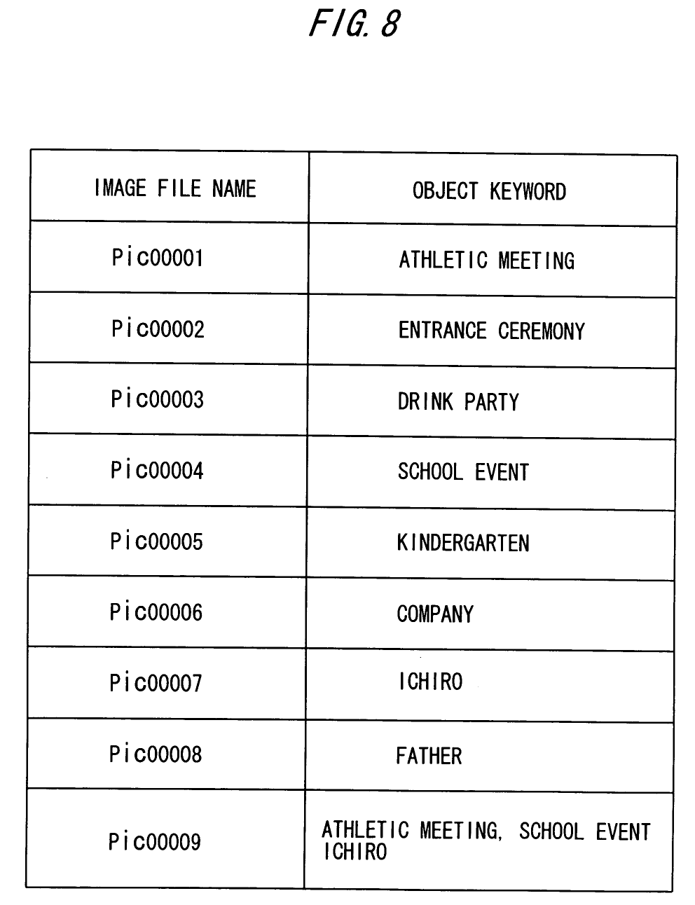

Further, each of the object images stored on the image database is assigned the object keyword as shown in FIG. 8. As to this object keyword, the storage unit 13 has a keyword table stored with pieces of identifying information (which are file names in this example) of the respective object images and the keywords in a way that associates the identifying information and object keywords with each other. It should be noted that the keyword may be assigned to each object image file without being limited to the structure for storing the independent table with the object keywords as described above. Furthermore, a property and a file name of the object image file may also be employed as the object keywords.

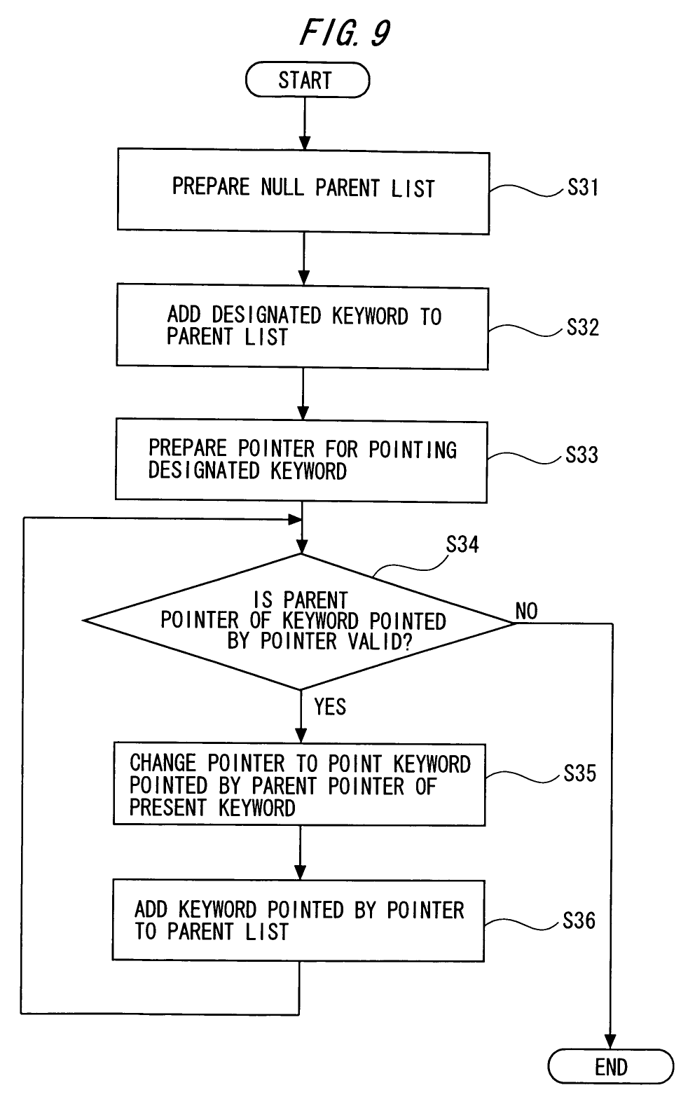

Given next is an explanation of a process of acquiring this object keyword and the parent list of the inputted keywords from the keyword tree. FIG. 9 is a flowchart of the process of acquiring this parent list.

The keyword evaluating unit 23, at first, prepares a null parent list (S31), and adds a designated keyword to the parent list (S32).

Then, the keyword evaluating unit 23 prepares a pointer that points the designated keyword on the keyword tree (S33), and judges whether the parent pointer of the keyword pointed by the pointer is valid or not (S34).

If this parent pointer is valid, the pointer is changed to point the keyword pointed by this parent pointer (S35).

After the change, the keyword pointed by the pointer is added to the parent list (S36), then the processing returns to step 34, and the steps 35 and 36 are repeated till the parent pointer becomes invalid, i.e., till the keyword on the uppermost layer is added to the parent list.

Through this process, if the object keyword is, e.g., “entrance ceremony”, the parent list consists of three keywords such as “Ichiro”, “School event” and “Entrance ceremony”. Further, if the inputted keyword is “Athletic meeting”, the parent list consists of three keywords such as “Ichiro”, “School event” and “Athletic meeting”. Hence, the number of the keywords contained in both is “2”, i.e., “Ichiro” and “School event”.

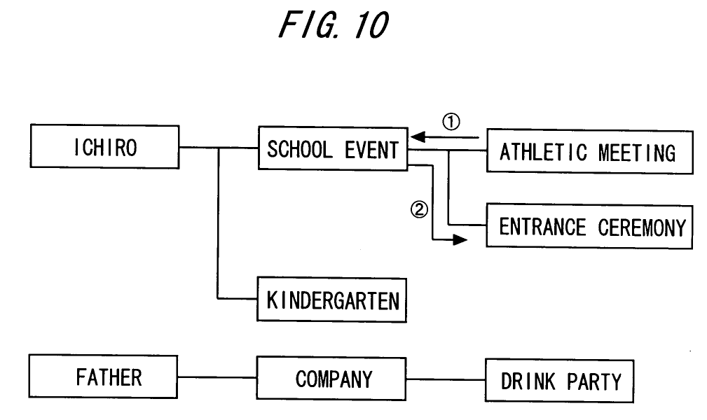

Note that a distance D between “Entrance ceremony” and “Athletic meeting” becomes, as shown in FIG. 10, the distance from the “Athletic meeting” to “School event” just above this keyword being “1” and the distance from “School event” to “Entrance ceremony” being “1”, therefore totally “2”. A formula for calculating this distance is the formula 1 given above.

To be specific, the distance D is given by:

$$\begin{matrix}D = CL 1 + CL 2 - 2 \times C \\ = 3 + 3 - 2 \times 2 \\ = 2\end{matrix} \qquad ( Formula 1 )$$

Then, the satisfaction level of “Entrance ceremony” with respect to the “Athletic meeting” is obtained from the formula 2 given above as follows.

$$\begin{matrix}M = {( 1 / 2 )}^{D} \\ = {( 1 / 2 )}^{2} \\ = 1 / 4\end{matrix} \qquad ( Formula 2 )$$

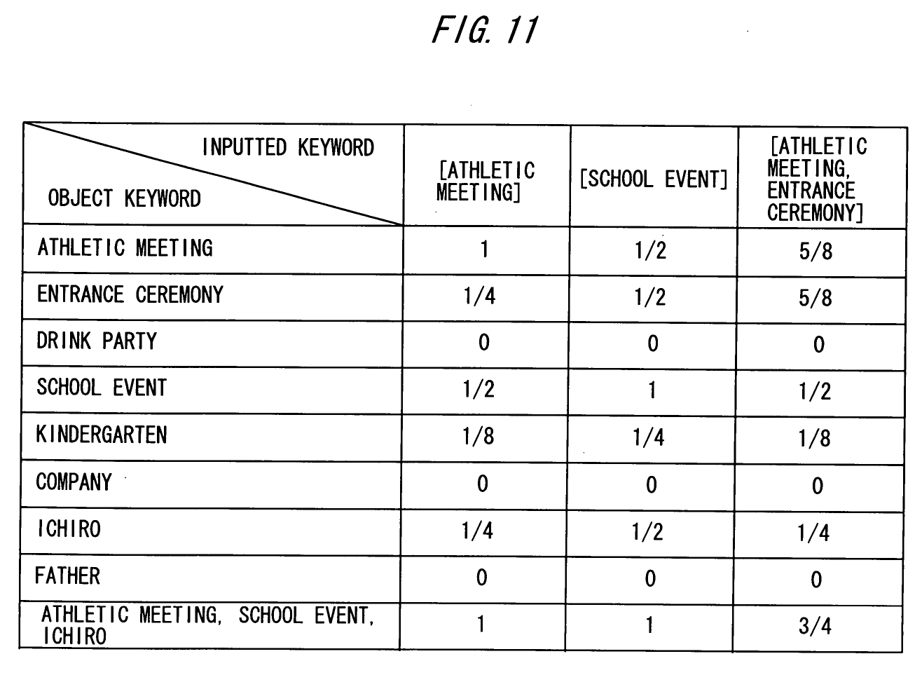

FIG. 11 shows an example of obtaining the satisfaction level from a hierarchical depth in the keyword tree as described above.

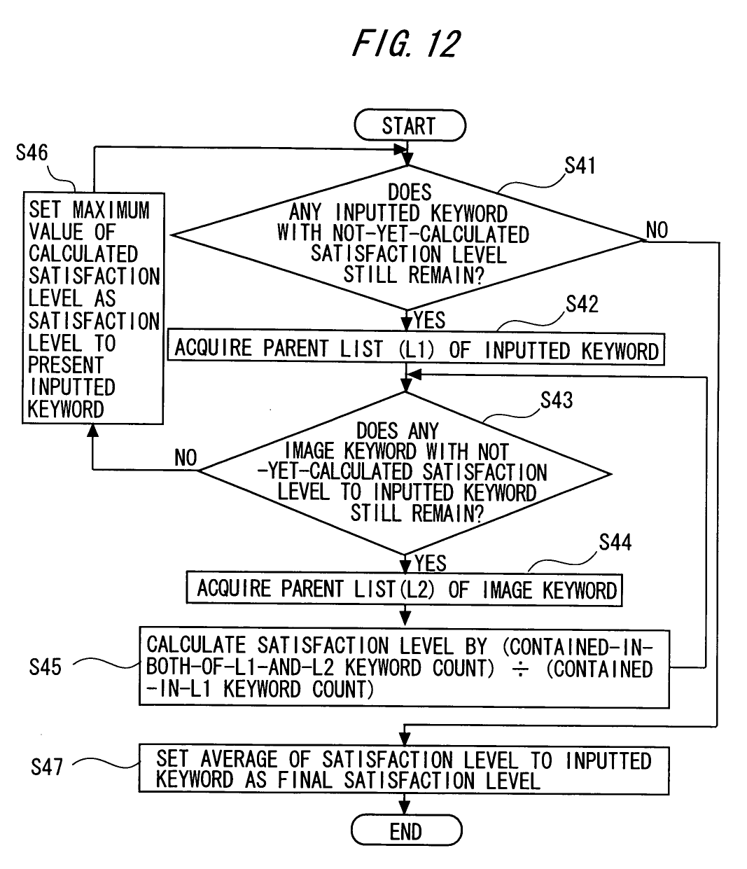

It should be noted that in the embodiment, the satisfaction level is obtained from the hierarchical depth of the keyword tree, however, without being limited to this method, other methods may also be usable if capable of obtaining, as a numerical value, the relational level between the object keyword and the inputted keyword. FIG. 12 is a flowchart of a process of calculating the satisfaction level from, for example, the keyword tree structure.

In this case, the keyword evaluating unit 23, to begin with, judges whether or not, in the inputted keywords, there remain any inputted keyword of which the satisfaction level is not yet calculated (S41). Hereat, if the not-yet-calculated inputted keyword remains, the parent list L1 of this inputted keyword is acquired (S42).

Further, the keyword evaluating unit 23 judges whether or not there remains, in the object keywords, any object keyword of which the satisfaction level to the inputted keyword is not yet calculated (S43). If the not-yet-calculated object keyword exists, the parent list (L2) of this object keyword is acquired (S44).

Then, the keyword evaluating unit 23 obtains the satisfaction level M of the keyword from the following formula (S45)
M=C/CL1 (Formula 3)

After obtaining this satisfaction level M, the keyword evaluating unit 23 returns to step 43, and repeats these steps (S44-S45) till there disappear the object keywords of which the satisfaction level M is not yet obtained. Then, if the object keywords of which the satisfaction level M should be obtained disappear, the maximum value in the satisfaction levels of the object keywords with respect to this inputted keyword is set as the satisfaction level to the inputted keyword (S46), and the processing returns to step 41.

In this step 41, the keyword evaluating unit 23 repeats the steps 42 through 46 till judging that none of the inputted keywords with the not-yet-obtained satisfaction level are left. Then, in the case of obtaining the satisfaction levels to all the inputted keywords, an average of the satisfaction levels to all these inputted keywords is determined as a final satisfaction level (S47).

For example, if the object keyword is “Entrance ceremony” and the inputted keyword is “Athletic meeting”, the satisfaction level M is given by:

$$\begin{matrix}M = C / CL 1 \\ = 2 / 3\end{matrix} \qquad ( Formula 3 )$$

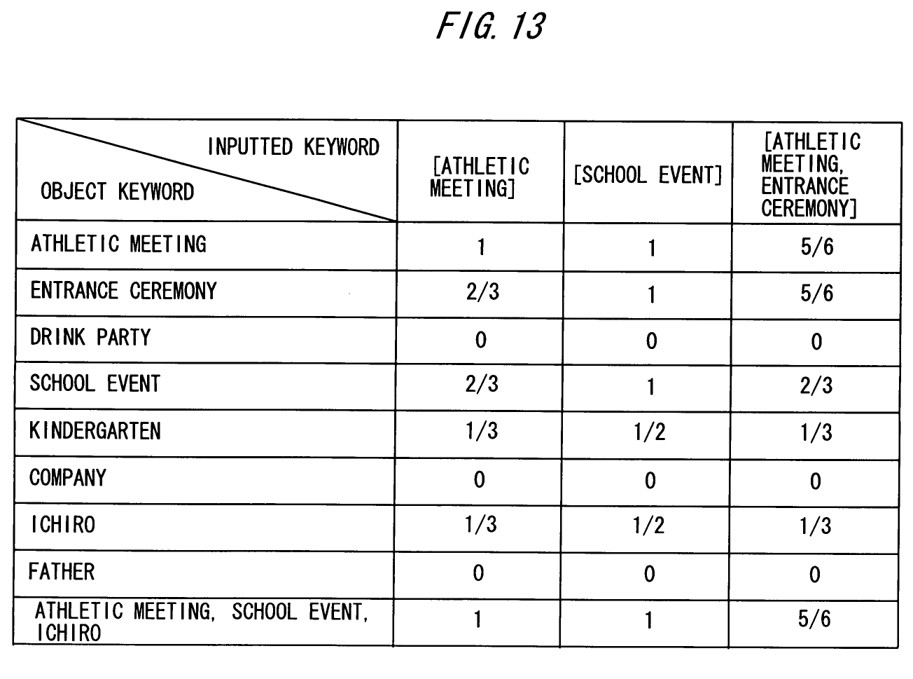

FIG. 13 shows an example of obtaining the satisfaction level from the keyword tree structure as described above.

As discussed above, according to the embodiment, the object images are displayed on the multidimensional coordinates in accordance with the satisfaction level of the keyword and the similarity level to the reference image, thereby enabling the desired image to be easily searched for.

### Second Embodiment

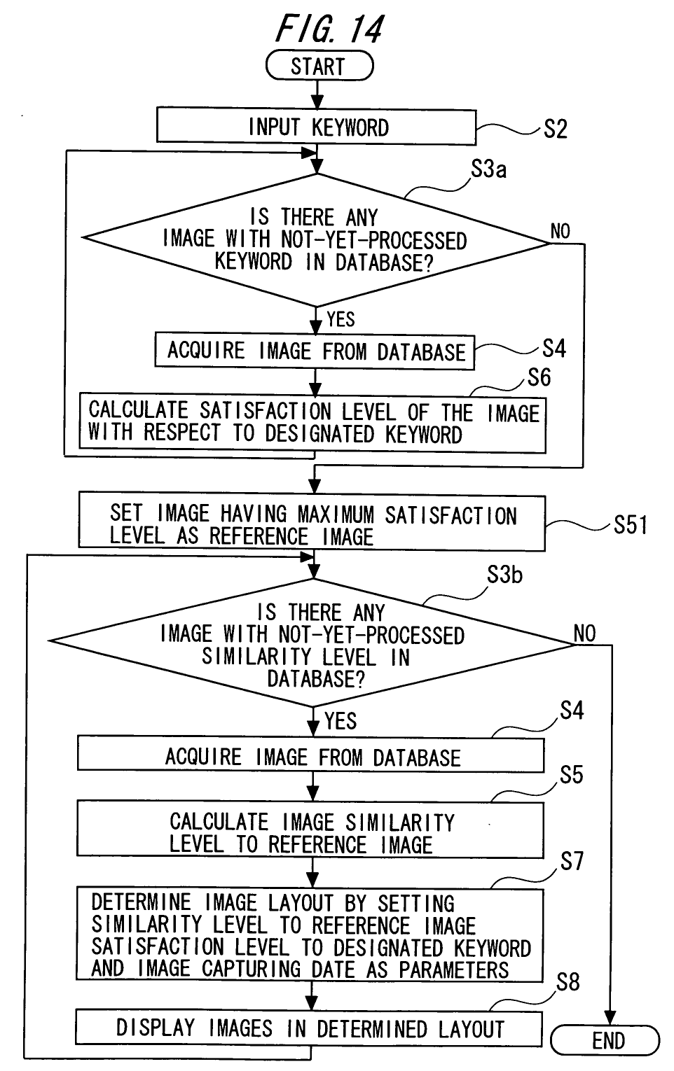

FIG. 14 is an explanatory diagram of the image display control method in a second embodiment according to the invention. The second embodiment is different from the first embodiment discussed above in terms of such a point that the reference image is not designated by the user but is determined by the image display control device, and other configurations are the same. Therefore, in the second embodiment, the same components are marked with the same numerals and symbols, and their repetitive explanations are omitted. It should be noted that the hardware configuration of the image search display device 1 in the second embodiment is the same as the hardware configuration in the first embodiment in FIG. 1.

When the user operates to start searching, the image search display device 1 reads the image display control program from the storage unit 13 and the executes the control program, thereby displaying, as shown in FIG. 3, the window 31 serving as the user interface on the display 16. When the user inputs a keyword (inputted keyword) of the want-to-search image to a keyword input box 33 on this window 31 from on the keyboard 15, the image search display device 1 receiving the input of the inputted keyword temporarily stores the inputted keyword on the main memory of the arithmetic processing unit 12 (S2).

Next, the image search display device 1 judges whether or not the image database contains any object image of which the satisfaction level to the inputted keyword is not yet calculated (S3a), and, if there is the not-yet-calculated object image, acquires this object image (S4).

With respect to this acquired object image, the keyword evaluating unit 23 calculates the satisfaction level, to the inputted keyword, of the object keyword assigned to the object image (S6). Thereafter, the processing returns to step 3a, and the steps 4 and 6 are repeated till the object image with the not-yet-calculated satisfaction level disappears.

Then, in the case of judging in step 3a that there is none of the object image of which the satisfaction level is not yet calculated, the object image exhibiting the maximum satisfaction level calculated is set as the reference image (S51).

Next, the image search display device 1 judges whether or not the image database contains any object image of which the similarity level to the reference image is not yet calculated (S3b), and, if the not-yet-calculated object image exists, this not-yet-calculated object image is acquired (S4).

The image evaluating unit 24 calculates the similarity level, to the reference image, of this acquired object image (S5).

The display control unit 25 determines the layout (coordinates) by using, as parameters, the satisfaction level of the object keyword, the similarity level of the image, an image capturing date and the image color distribution (S7), and displays, in this layout, as illustrated in FIG. 4, a reduced image (thumbnail image) in a result display box 37 on the window 31 (S8).

Thus, according to the second embodiment, the reference image is determined based on the keyword inputted by the user without the reference image's being designated by the user, whereby the simple operation enables the search for the desired image.

Others

The invention is not limited to only the illustrated examples given above and can be, as a matter of course, changed in a variety of forms in the range that does not deviate from the gist of the invention.

For example, even the configurations given in the following Notes can acquire the same effects as those in the embodiments discussed above. Further, the components thereof can be combined to the greatest possible degree.

### Incorporation by Reference

The disclosures of Japanese patent application No. JP2005-301429 filed on Oct. 17, 2005 including the specification, drawings and abstract are incorporated herein by reference.

What is claimed is:

1. An image display control device that displays a plurality of object images in a layout corresponding to similarity levels thereof, comprising:
a keyword input unit receiving an input of a keyword;
a reference image selecting unit selecting a reference image;
a keyword evaluating unit calculating a satisfaction level of the keyword on the basis of a keyword assigned to each object image and the inputted keyword;
a image evaluating unit calculating a similarity level of each object image by comparing the object image with the reference image; and
a display control unit having the respective object images displayed in the layout corresponding to the satisfaction level of the keyword and the similarity level of the image.

2. An image display control device according to claim 1, wherein the display control unit displays the plurality of images on coordinates corresponding to the satisfaction levels and the similarity levels thereof, in which at least the satisfaction level of the keyword and the similarity level of the image are taken on coordinate axes.

3. An image display control device according to claim 1, wherein the keyword evaluating unit refers to a keyword table stored hierarchically with the keywords, and calculates the satisfaction level on the basis of a difference in hierarchy between the keyword assigned to the object image and the inputted keyword.

4. An image display control device according to claim 1, wherein the reference image selecting unit selects, as the reference image, an image exhibiting the satisfaction level of keyword that satisfies a predetermined condition in the plurality of the object images.

5. An image display control method by which a computer displays a plurality of object images in a layout corresponding to similarity levels thereof, the control method comprising steps of:
receiving an input of a keyword;
selecting a reference image;
calculating a satisfaction level on the basis of a keyword assigned to each object image and the inputted keyword;
calculating a similarity level of each object image by comparing the object image with the reference image; and
having the respective object images displayed in the layout corresponding to the satisfaction level of the keyword and the similarity level of the image.

6. An image display control method according to claim 5, wherein the object image displaying step involves displaying the plurality of images on coordinates corresponding to the satisfaction levels and the similarity levels thereof, in which at least the satisfaction level of the keyword and the similarity level of the image are taken on coordinate axes.

7. An image display control method according to claim 5, wherein the satisfaction level of keyword calculating step involves referring to a keyword table stored hierarchically with the keywords, and calculating the satisfaction level on the basis of a difference in hierarchy between the keyword assigned to the object image and the inputted keyword.

8. An image display control method according to claim 5, wherein the reference image selecting step involves selecting, as the reference image, an image exhibiting the satisfaction level of keyword that satisfies a predetermined condition in the plurality of the object images.

9. A recording medium recorded with an image display control program for making a computer displays a plurality of object images in a layout corresponding to similarity levels thereof, the control program comprising steps of:
receiving an input of a keyword;
selecting a reference image;
calculating a satisfaction level on the basis of a keyword assigned to each object image and the inputted keyword;
calculating a similarity level of each object image by comparing the object image with the reference image; and
having the plurality of object images displayed in the layout corresponding to the satisfaction level of the keyword and the similarity level of the image.

10. A recording medium according to claim 9, wherein the object image displaying step involves displaying the plurality of images on coordinates corresponding to the satisfaction levels and the similarity levels thereof, in which at least the satisfaction level of the keyword and the similarity level of the image are taken on coordinate axes.

11. A recording medium according to claim 9, wherein the satisfaction level of keyword calculating step involves referring to a keyword table stored hierarchically with the keywords, and calculating the satisfaction level on the basis of a difference in hierarchy between the keyword assigned to the object image and the inputted keyword.

12. A recording medium according to claim 9, wherein the reference image selecting step involves selecting, as the reference image, an image exhibiting the satisfaction level of keyword that satisfies a predetermined condition in the plurality of the object images.
